(19) United States
(12) Patent Application Publication
(10) Pub. No.: US 2008/0159286 A1
(43) Pub. Date: Jul. 3, 2008

(54) CONTEXTUALIZED BROADCAST MESSAGE CHANNEL FOR ACTIVITY-CENTRIC COLLABORATIVE COMPUTING

(76) Inventors: Martin T. Moore, Somerville, MA (US); Shilad W. Sen, Minneapolis, MN (US); Werner Geyer, Boston, MA (US); Michael Muller, Medford, MA (US); Michael Chi Hung Wu, Toronto (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/617,114

(22) Filed: Dec. 28, 2006

(51) Int. Cl. H04L 12/56

(52) U.S. Cl. 370/390; 370/401

(57) ABSTRACT

Embodiments of the present invention address deficiencies of the art in respect to broadcast messaging in a collaborative environment and provide a method, system and computer program product for contextualized broadcast messaging for activity-centric collaborative computing. In one embodiment of the invention, a method of contextualized broadcast messaging for activity-centric collaborative computing can be provided. The method can include selecting an activity in an activity-centric collaborative computing environment, retrieving a listing of members associated with the selected activity, creating a broadcast message designating the members as recipients of the broadcast message, and issuing the broadcast message to the members.

### BACKGROUND OF THE INVENTION

1. Field of the Invention

The present invention relates to the field of collaborative computing and more particularly to informal messaging of collaborators in an activity-centric collaborative computing environment.

2. Description of the Related Art

Collaborative computing refers to the use by two or more end users of a computing application in order to achieve a common goal. Initially envisioned as a document sharing technology among members of a small workgroup in the corporate environment, collaborative computing has grown today to include a wide variety of technologies arranged strategically to facilitate collaboration among groups as small as two people, or as large as a world-wide community. Thus, different collaborative applications may focus upon groups of different sizes. No longer merely restricted to document sharing, the modern collaborative environment can include document libraries, chat rooms, video conferencing, application sharing, and discussion forums to name only a few.

A collaborative computing application enjoys substantial advantages over a more conventional, individualized computing application. Specifically, at present it is rare that a goal of any importance is entrusted and reliant upon a single person. In fact, many goals and objectives can be achieved only through the participation of a multiplicity of individuals, each serving a specified role or roles in the process. Consequently, to provide computing tools designed for use only by one of the individuals in the process can be short sighted and can ignore important potential contributions lying among the other individuals involved in the process.

The collaborative computing environment often aims to simulate a shared physical work environment. In a shared physical space, people collaborate differently at different times, but one of the most valuable collaboration channels is the ability of a collaborator to speak to the entire group of collaborators informally. For example, a worker may alert his co-workers to a prospective action by raising the worker's voice to the team. This form of broadcast messaging can be valuable because broadcast messaging can be time and context-sensitive, and collaborators who hear the broadcast message can choose to ignore the notice, engage the rest of their workers with a response, or formulate a private response to the person who initially spoke. Finally, the interaction is informal and ad hoc—no decision need be made about technologies in advance, and no formal record need be kept.

Traditional collaborative computing environments separate work products into different silos depending on the tools used to accomplish the work. The goal of activity-centric computing is to bridge the gaps between tool boundaries by horizontally integrating different collaboration tools in a single conceptual context—the “activity”. Notably, few activity-centric collaborative computing environments approximate access to this same type of real world voice broadcast channel, but the need to collaborate in this manner remains. In substitute, collaborators in an activity-centric computing environment have employed a variety of messaging technologies to approximate voice broadcasting. E-mail is commonly used, but e-mails clog inboxes with messages that are often meaningless outside of a particular context (either time or project-sensitive). Some collaborative computing tools have introduced a virtual broadcast channel that behaves similar to instant messaging in that the broadcast messages are delivered in real-time to the target recipients of the broadcast.

These approximating tools still suffer from a number of problems. For instance, collaborators are either unable to respond at all to broadcast messages or the collaborator initiating the broadcast must know a priori what kind of response is desired, for instance joining a chat, answering a poll or submitting a response to a particular question. Additionally, there isn't an easy way to send a broadcast message in the context of a user's current activity. In this regard, if a user is preparing to perform a task in an activity the user may want to alert all the people involved in the activity with this information. To do so, however, requires the user to manually gather the names of those collaborators associated with the activity. Additionally, the broadcast message and any collaborations resulting from it are not automatically associated with the activity, fragmenting the work and making it harder to keep track of

### BRIEF SUMMARY OF THE INVENTION

Embodiments of the present invention address deficiencies of the art in respect to broadcast messaging in a collaborative environment and provide a novel and non-obvious method, system and computer program product for contextualized broadcast messaging for activity-centric collaborative computing. In one embodiment of the invention, a method of contextualized broadcast messaging for activity-centric collaborative computing can be provided. The method can include selecting an activity in an activity-centric collaborative computing environment, retrieving a listing of members associated with the selected activity, creating a broadcast message designating the members as recipients of the broadcast message, and issuing the broadcast message to the members.

The method further can include receiving a non-broadcast message response to the issued broadcast message from at least one of the members, and adding the broadcast message to the activity in the activity-centric collaborative computing environment. In this regard, adding the broadcast message to the activity in the activity-centric collaborative computing environment can include encapsulating the broadcast message as an activity object, and inserting the activity object in an activity thread for the activity. Additionally, the method can include encapsulating the non-broadcast message response as an activity object, and inserting the activity object in the activity thread for the activity as a child of the inserted activity object for the broadcast message.

In another embodiment of the invention, an activity-centric collaboration data processing system configured for contextualized broadcast messaging can be provided. The system can include an activity-centric collaboration tool configured for managing a plurality of activities, a broadcast messenger configured to broadcast messages to different users of the activity-centric collaboration data processing system, and broadcast message integration logic. The logic can include program code enabled to address a broadcast message to members associated with a selected one of the activities. The program code further can be enabled to add the broadcast message to the selected one of the activities responsive to receiving a non-broadcast message response to the broadcast message.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a progression of user interface screens resulting from contextualized broadcast messaging for activity-centric collaborative computing;

FIG. 2 is a schematic illustration of activity-centric collaborative computing data processing system configured for contextualized broadcast messaging; and,

FIG. 3 is a flow chart illustrating a process for contextualized broadcast messaging for activity-centric collaborative computing.

### DETAILED DESCRIPTION OF THE INVENTION

Embodiments of the present invention provide a method, system and computer program product for contextualized broadcast messaging for activity-centric collaborative computing. In accordance with an embodiment of the present invention, a broadcast message can be associated with an activity and broadcast to all members of the activity. The broadcast message can be logged and, if a response to the broadcast message, such as an automated e-mail response, is received, the broadcast message and response can be added to the activity. In this way, an ad-hoc response to the broadcast message can be permitted and the context of the broadcast message will be understood in relation to the position of the broadcast message in the activity.

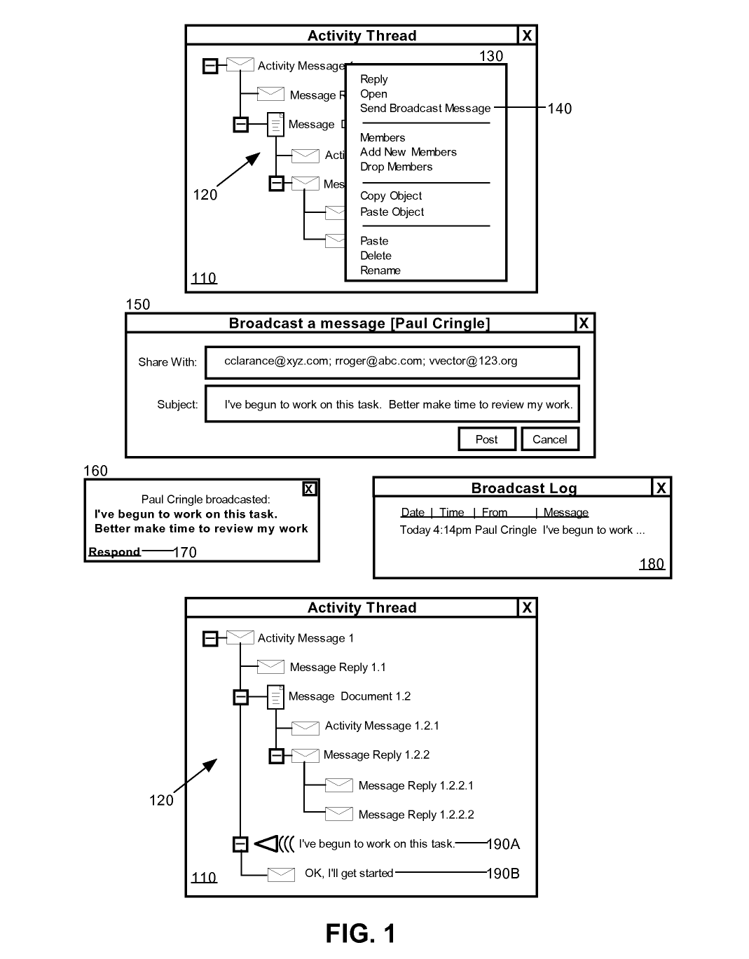

In further illustration, FIG. 1 is a pictorial illustration of a progression of user interface screens resulting from contextualized broadcast messaging for activity-centric collaborative computing. As shown in FIG. 1, an activity thread view 110 of an activity thread 120 can include a hierarchical arrangement of activity objects such as tasks, documents, messages and the like, all pertaining to the completion of an activity. Each activity object in the activity 120 can be selectable such that a pop-up menu 130 can be provided in response to the activation of a corresponding activity object. The pop-up menu 130 can provide a listing of actions able to be performed in association with the selected activity object, for instance replying to a message, opening a view to a task, viewing members associate with the task, and the like.

Within the pop-up menu 130, a broadcast message option 140 for broadcasting a message to the members of an activity can be provided. The broadcast message option 140 when selected can launch a broadcast message user interface 150 through which a broadcast message can be composed for transmission to the members of the activity. Notably, the broadcast message user interface 150 can automatically fill the recipient list with a listing of members of the activity without requiring the end user to manually enter the listing of members of the activity. Furthermore, because the broadcast message user interface 150 can automatically fill the recipient list, there is no need to identify a proper grouping of members of the activity as the grouping is inherent to the activity.

The posting of a message through the broadcast message user interface 150 can result in a real-time alert 160 triggered where permitted for each member of the activity. Additionally, the message can be inserted into a broadcast log 180 for the activity so that the broadcast message can be accessed asynchronously by the members of the activity. Importantly, the alert 160 can include a response control 170. The response control 170 can be configured to trigger a response to the sender of the broadcast message in the alert 160, for instance a message, a chat, a shared file, a created task, another broadcast message and so forth. When a response to the broadcast message is provided, the broadcast message and the response can be separately encapsulated in respective activity objects 190A, 190B and inserted into the activity thread 120. In this way, context can be established for the broadcast message where the broadcast message has been deemed important enough to elicit a response.

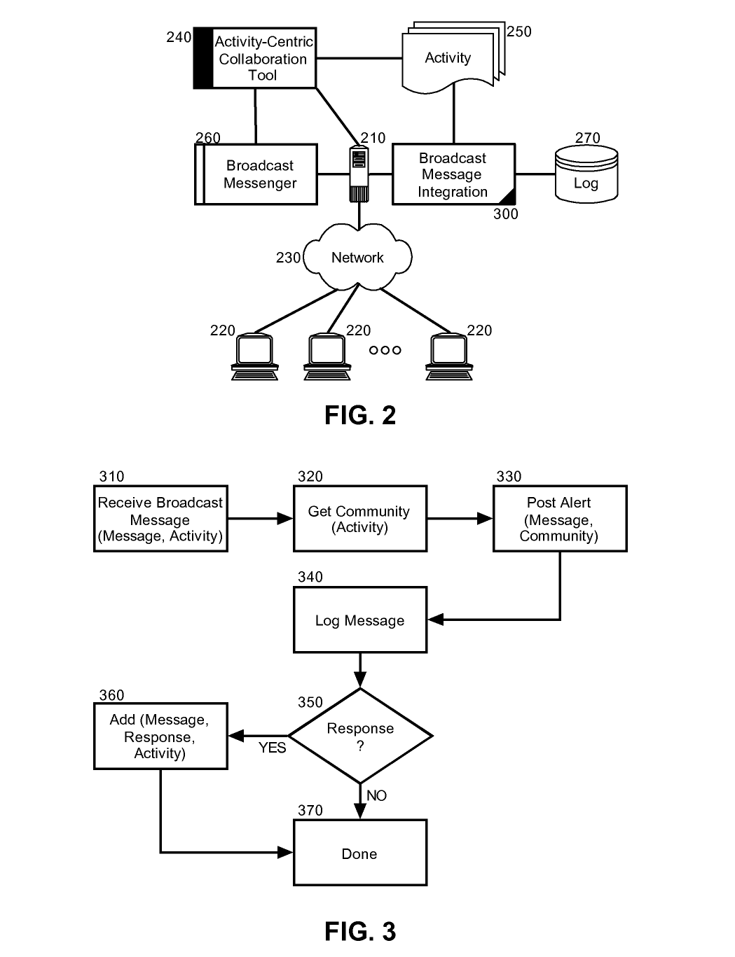

Turning now to FIG. 2, a schematic illustration of activity-centric collaborative computing data processing system is shown wherein the system is configured for contextualized broadcast messaging. The system can include a host computing platform 210 coupled to one or more client computing platforms 220 over a computer communications network 230. The host computing platform can support the operation of an activity-centric collaboration tool such as the Activity Explorer(TM) within the IBM Workplace Managed Client(TM) manufactured by International Business Machines Corporation of Armonk, N.Y., United States of America. The activity-centric collaboration tool 240 can manage one or more activities 250, each of the activities 250 including one or more activity objects such as tasks, documents, messages and the like, organized in a hierarchy known as an activity thread.

Notably, a broadcast messenger 260 can be coupled to the activity-centric collaboration tool 240. The broadcast messenger 260 can be configured to render broadcast messages to specified users in which each message once broadcast appears to the recipient as an alert or other pop-up type user interface window with a short message. In addition to the broadcast messenger 260, broadcast message integration logic 300 further can be supported by the host computing platform 210 and coupled to the broadcast messenger 260.

The broadcast message integration logic 300 can include program code enabled to place broadcast messages issued by the broadcast messenger 260 in a coupled log 270. Additionally, the program code can be enabled to associate a broadcast message with a selected one of the activities 250 such that the recipient list for the broadcast message can be automatically derived from the member list of the selected one of the activities 250. Finally, the program code for the broadcast message integration logic 300 can be enabled to add each broadcast message as an activity object to the selected one of the activities 250 whenever a non-broadcast message response is received for the broadcast message from one of the recipients of the broadcast message.

In yet further illustration of the operation of the broadcast message integration logic 300, FIG. 3 is a flow chart illustrating a process for contextualized broadcast messaging for activity-centric collaborative computing. Beginning inblock 310, a broadcast message request can be received with a specified message and an associated activity. In block 320, the community of members for the associated activity can be retrieved and in block 330, an alert can be provided with the specified message to each member of the community. Thereafter, in block 340, the broadcast message can be written to a broadcast message log.

In decision block 350 it can be determined whether a response has been provided to the alert from any of the members of the community receiving the broadcast message. If so, in block 360, the message can be encapsulated in an activity object and added to the associated activity. Likewise, the response to the broadcast message can be encapsulated in an activity object and added to the associated activity as a child to the activity object encapsulating the message from the broadcast message. In this way, context can be added to the broadcast message only where the broadcast message had enough of an impact to elicit at least one response from a recipient of the broadcast message so as to avoid clogging the activity thread with excessive broadcast messages.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A method of contextualized broadcast messaging for activity-centric collaborative computing, the method comprising:
selecting an activity in an activity-centric collaborative computing environment;
retrieving a listing of members associated with the selected activity;
creating a broadcast message designating the members as recipients of the broadcast message;
issuing the broadcast message to the members; and,
logging the broadcast message in a separate broadcast message log.

2. (canceled)

3. The method of claim 1, further comprising:
receiving a non-broadcast message response to the issued broadcast message from at least one of the members; and,
adding the broadcast message to the activity in the activity-centric collaborative computing environment.

4. The method of claim 3, wherein receiving a non-broadcast message response to the issued broadcast message from at least one of the members, comprises receiving an e-mail in response to the issued broadcast message from at least one of the members.

5. The method of claim 3, wherein receiving a non-broadcast message response to the issued broadcast message from at least one of the members, comprises receiving a chat invitation in response to the issued broadcast message from at least one of the members.

6. The method of claim 3, wherein receiving a non-broadcast message response to the issued broadcast message from at least one of the members, comprises creating a task in response to the issued broadcast message from at least one of the members.

7. The method of claim 3, wherein adding the broadcast message to the activity in the activity-centric collaborative computing environment comprises:
encapsulating the broadcast message as an activity object; and,
inserting the activity object in an activity thread for the activity.

8. The method of claim 7, further comprising:
encapsulating the non-broadcast message response as an activity object; and,
inserting the activity object in the activity thread for the activity as a child of the inserted activity object for the broadcast message.

9. An activity-centric collaboration data processing system configured for contextualized broadcast messaging, the system comprising:
an activity-centric collaboration tool configured for managing a plurality of activities;
a broadcast messenger configured to broadcast messages to different users of the activity-centric collaboration data processing system;
broadcast message integration logic comprising program code enabled to address a broadcast message to members associated with a selected one of the activities; and,
broadcast message log.

10. (canceled)

11. The system of claim 9, wherein program code is further enabled to add the broadcast message to the selected one of the activities responsive to receiving a non-broadcast message response to the broadcast message.

12. A computer program product comprising a computer usable medium embodying computer usable program code for contextualized broadcast messaging for activity-centric collaborative computing, the computer program product comprising:
computer usable program code for selecting an activity in an activity-centric collaborative computing environment;
computer usable program code for retrieving a listing of members associated with the selected activity;
computer usable program code for creating a broadcast message designating the members as recipients of the broadcast message;
computer usable program code for issuing the broadcast message to the members; and
computer usable program code for logging the broadcast message in a separate broadcast message log.

13. (canceled)

14. The computer program product of claim 12, further comprising:
computer usable program code for receiving a non-broadcast message response to the issued broadcast message from at least one of the members; and,
computer usable program code for adding the broadcast message to the activity in the activity-centric collaborative computing environment.

15. The computer program product of claim 14, wherein the computer usable program code for receiving a non-broadcast message response to the issued broadcast message from at least one of the members, comprises computer usable program code for receiving an e-mail in response to the issued broadcast message from at least one of the members.

16. The computer program product of claim 14, wherein the computer usable program code for receiving a non-broadcast message response to the issued broadcast message from at least one of the members, comprises computer usable program code for receiving a chat invitation in response to the issued broadcast message from at least one of the members.

17. The computer program product of claim 14, wherein the computer usable program code for receiving a non-broadcast message response to the issued broadcast message from at least one of the members, comprises computer usable program code for creating a task in response to the issued broadcast message from at least one of the members.

18. The computer program product of claim 14, wherein the computer usable program code for adding the broadcast message to the activity in the activity-centric collaborative computing environment comprises:
computer usable program code for encapsulating the broadcast message as an activity object; and,
computer usable program code for inserting the activity object in an activity thread for the activity.

19. The computer program product of claim 18, further comprising:
computer usable program code for encapsulating the non-broadcast message response as an activity object; and,
computer usable program code for inserting the activity object in the activity thread for the activity as a child of the inserted activity object for the broadcast message.
